(19) United States
(12) Patent Application Publication
(10) Pub. No.: US 2018/0130166 A1
(43) Pub. Date: May 10, 2018

(54) IMAGE PROCESSING APPARATUS AND CONTROL METHOD THEREOF, AND INTEGRATED CIRCUIT

(71) Applicant: SHARP KABUSHIKI KAISHA, Sakai City, Osaka (JP)

(72) Inventor: TAKESHI KUMAKURA, Sakai City (JP)

(21) Appl. No.: 15/574,594

(22) PCT Filed: May 11, 2016
(86) PCT No.: PCT/JP2016/063994

§ 371 Date: Nov. 16, 2017

(30) Foreign Application Priority Data
May 28, 2015 (JP) 2015-109029

(51) Int. Cl. G06T 1/00; H04N 1/46; H04N 9/64

(52) U.S. Cl. CPC G06T 1/0007; H04N 9/64; H04N 1/46

(57) ABSTRACT

A plurality of video images indicated by a plurality of video data each having different color gamuts are displayed on one screen in colors each close to the colors of original video images. A color gamut specifying unit (34) specifies a color gamut to which each of the plurality of video data conforms. A video processing circuit (14) converts the plurality of video data into display data including the plurality of video images to be displayed on one screen of a display unit (15), and also performs conversion into the display data conforming to a color gamut of the display unit (15) on the basis of the color gamut specified by the color gamut specifying unit (34).

### TECHNICAL FIELD

The present invention relates to an image processing apparatus configured to perform image processing on image data and a control method thereof as well as an integrated circuit.

### BACKGROUND ART

In recent years, video signals available for reproducing a wider color gamut than color gamut in the related art have been proposed as a part of advanced broadcasting. Specifically, the color gamut according to the ITU-R BT.2020 standard (hereinafter abbreviated as “BT.2020 standard”) established by International Telecommunications Union is significantly wider than the color gamut according to the ITU-R BT.709 standard (hereinafter abbreviated as “BT.709 standard”) having been used in the related art. In 2014, 4K test broadcasting adopting the BT.2020 standard started, and the BT.2020 standard is expected to be adopted mainly in 4K/8K Ultra-High Definition Television (UHDTV) broadcasting.

On the other hand, High Definition Television (HDTV) broadcasting adopting the BT.709 standard in the related art is also expected to be continued. Accordingly, in future a television (TV) receiver is required to support the both of a narrow color gamut based on the BT.709 standard and a wide color gamut based on the BT.2020 standard. This is because a color indicated by a pixel value (for example, (R, G, B) is (0, 255, 0)) based on the BT.709 standard is different from a color indicated based on the BT.2020 standard.

The following processing is included in the processing which supports the both of the BT.709 standard and the BT.2020 standard. That is, in the processing, the TV receiver determines whether the color gamut of a received video signal is based on the BT.709 standard or the BT.2020 standard, and the TV receiver converts the video signal so as to allow reproduction of the determined color gamut. As citation documents relating to such color gamut conversion, for example, the following documents of PTL 1 to PTL 3 are cited.

### CITATION LIST

### Patent Literature

PTL 1: JP 2010-278909 A (published on Dec. 9, 2010)

PTL 2: JP 2008-219791 A (published on Sep. 18, 2008)

PTL 3: JP 2008-141723 A (published on Jun. 19, 2008)

### SUMMARY OF INVENTION

### Technical Problem

Some of the TV receivers in the related art are so-called multi-display type TV receivers each of which receives a plurality of broadcast signals and displays, on one screen, the plurality of video images each indicated by the plurality of received broadcast signals.

This multi-display type TV receiver is required to display, on one screen, HDTV video images and UHDTV video images having different color gamuts. In this case, if the entire screen is displayed in one of the HDTV color gamut and the UHDTV color gamut, the video conforming to one color gamut is displayed in colors close to those of the original video thereof, but the video conforming to the other color gamut is displayed in different colors from those of the original video.

The present invention has been made in view of the problem, and an object of the invention is to provide an image processing apparatus and the like capable of, even when a plurality of image data having different color gamuts are acquired, displaying a plurality of images indicated by the plurality of image data in colors close to those of the original images on a display device.

### Solution to Problem

To solve the problem, the image processing apparatus of an aspect of the present invention configured to perform image processing on image data includes an acquisition unit and a conversion unit, and further includes a specifying unit. The acquisition unit is configured to acquire a plurality of image data. The conversion unit is configured to convert the plurality of image data acquired by the acquisition unit into display data including a plurality of images each indicated by the plurality of image data. The plurality of images are to be displayed on one screen of a display device. The specifying unit is configured to specify a color gamut. Each of the plurality of image data conforms to the color gamut. The conversion unit converts the plurality of image data into the display data conforming to a color gamut of the display device on the basis of the color gamut specified by the specifying unit.

### Advantageous Effects of Invention

One aspect of the present invention exhibits such an effect that, even when a plurality of image data having different color gamuts are acquired, a display device is capable of displaying a plurality of images indicated by the plurality of image data in colors each close to the colors of original images.

### BRIEF DESCRIPTION OF DRAWINGS

FIG. 1 is a block diagram illustrating a schematic constitution of a TV receiver according to one embodiment of the present invention.

FIG. 2 is a diagram illustrating an example of a plurality of windows set on a screen of a display unit of the TV receiver.

FIGS. 3A to 3C are diagrams illustrating, each in a table format, an example of window setting information set in the TV receiver.

FIG. 4 is a diagram illustrating, in a table format, an example of a color gamut identification table used in the TV receiver.

FIG. 5 is a block diagram illustrating a schematic constitution of a window processing unit in the TV receiver.

FIGS. 6A to 6C are diagrams illustrating data for each color gamut to be output in response to input data with respect to a 3 Dimension-Look tip Table (3D-LUT) used by a color gamut adjustment unit in the TV receiver.

FIG. 7 is a block diagram illustrating a schematic constitution of the color gamut adjustment unit in the TV receiver.

FIG. 8 is a block diagram illustrating a schematic constitution of a 3D-LUT processing unit used in the color gamut adjustment unit.

FIG. 9 is a block diagram illustrating a schematic constitution of a color gamut adjustment unit in a TV receiver according to another embodiment of the present invention.

FIG. 10 is a block diagram illustrating a schematic constitution of a window processing unit in a TV receiver according to another embodiment of the present invention.

FIG. 11 is a diagram illustrating, in a table format, an example of a window position table stored in the window processing unit.

### DESCRIPTION OF EMBODIMENTS

An embodiment of the present invention will be described in detail below. Note that for simplicity, components illustrated in respective embodiments are designated by the same reference numerals as those having the same function, and description thereof are omitted as appropriate.

### First Embodiment

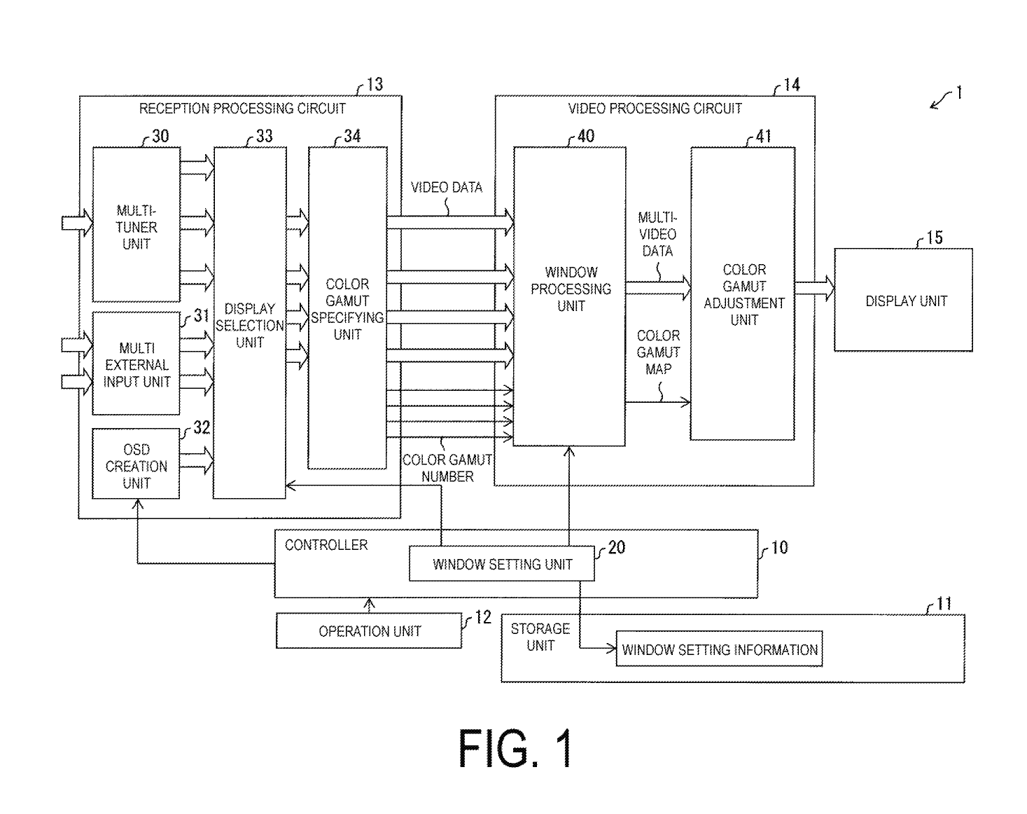

One embodiment of the present invention will be described with reference to FIG. 1 to FIG. 8.

### Outline of TV Receiver

FIG. 1 is a block diagram illustrating a schematic constitution of a TV receiver according to the present embodiment. The TV receiver 1 of the present embodiment is the multi-display type TV receiver described above, and supports the BT.2020 standard. As illustrated in the figure, the TV receiver 1 is constituted to include a controller 10, a storage unit 11, an operation unit 12, a reception processing circuit (image processing apparatus) 13, a video processing circuit (image processing apparatus) 14, and a display unit (display device) 15. Note that the term of “video” indicated below includes a still image as well as a moving image.

The controller 10 is a unit configured to integrally control various constitutions inside the TV receiver 1, and is constituted to include a processor such as Central Processing Unit (CPU). The storage unit 11 is a unit configured to store various types of data and programs, and is constituted to include a storage element such as Random Access Memory (RAM), Read Only Memory (ROM), and a flash memory.

The operation unit 12 is a unit configured to create operation data in response to user's operation on an input device provided on the TV receiver 1 or a remote controller for remote operation to the TV receiver 1, and transmit the created operation data to the controller 10. Examples of the input device include a button switch and a touch panel.

The reception processing circuit 13 is a circuit configured to receive a signal including video data (image data) from the outside, and perform reception processing such as demultiplexing and decoding on the received signal to acquire the video data. The reception processing circuit 13 supplies the acquired video data to the video processing circuit 14.

Examples of the signal received by the reception processing circuit 13 include a broadcast signal broadcast via each of various broadcasting media such as terrestrial digital broadcasting, Broadcasting Satellite (BS) broadcasting, Communications Satellite (CS) broadcasting, cable broadcasting, and Internet broadcasting, and an Audio-Visual (AV) signal received from an external device such as a Hard Disk Drive (HDD), a Blu-ray Disc (BD) drive, a Personal Computer (PC), and a mobile phone. In the present embodiment, the reception processing circuit 13 creates an On-Screen Display (OSD) image on the basis of an instruction transmitted by the controller 10, and supplies the data of the created OSD image to the video processing circuit 14 as the video data.

The video processing circuit 14 is a circuit configured to perform video processing (image processing) such as image quality adjustment and scaling on the video data supplied by the reception processing circuit 13. The video processing circuit 14 supplies the data after the video processing to the display unit 15 as display data. The image quality adjustment in the embodiment is to change at least any one of luminance, sharpness and contrast, for example. The scaling is to enlarge or reduce the size of an image to be displayed while maintaining the original aspect ratio of the image.

The display unit 15 is a unit configured to perform displaying on a display screen on the basis of the display data supplied by the video processing circuit 14. Specifically, the display unit 15 is constituted to include a display element and a driver circuit. Examples of the display element include Liquid Crystal Display (LCD), an Electroluminescence (EL) display, and an electronic paper. The driver circuit is configured to drive the display element on the basis of the supplied display data.

In the present embodiment, the video processing circuit 14 performs conversion into the display data to be displayed on one screen of the display unit 15, the display data including a plurality of video images each indicated by the plurality of video data supplied by the reception processing circuit 13. This allows the display unit 15 to display the plurality of video images on one screen (multi-display). Further, the reception processing circuit 13 specifies a color gamut to which each of the plurality of video data conforms. The video processing circuit 14 adjusts the plurality of video data on the basis of the specified color gamut so as to create the display data conforming to the color gamut of the display unit 15. Accordingly, even when a plurality of video data having different color gamuts are acquired, the display unit 15 is capable of displaying each of the plurality of video images in the same colors as or colors close to those of original video images.

### Detail of Controller

Next, each block in the TV receiver 1 will be described in detail. As illustrated in FIG. 1, the controller 10 is constituted to include a window setting unit 20. The window setting unit 20 is a unit configured to set a plurality of display areas (windows) on the screen of the display unit 15, and set which of the plurality of video images indicated by the plurality of video signals received by the reception processing circuit 13 is to be displayed in each of the set windows. The window setting unit 20 stores the set information as window setting information (image map) in the storage unit 11, and also transmits the window setting information to the reception processing circuit 13 and the video processing circuit 14. Note that various types of setting in the window setting unit 20 may be performed by a user via the operation unit 12, or may be automatically performed by the controller 10.

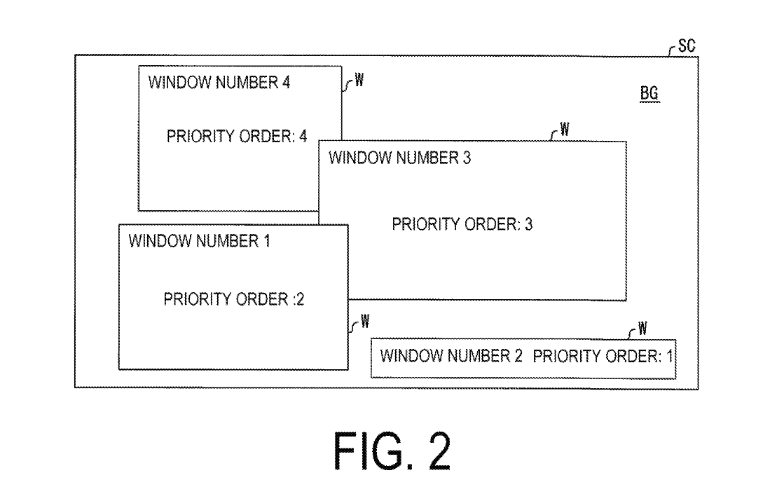

FIG. 2 is a diagram illustrating an example of a plurality of windows W set on a screen SC of the display unit 15. As illustrated in the figure, in the present embodiment, each of the windows W has a rectangular area, but such an area is not limited to this. The windows W may be partially superimposed with each other. To each of the windows W, a window number for identification of each window W and a priority order indicating which of the windows W is prioritized for indication are assigned. Accordingly, in each of the superimposed portions, the video of the window W having the highest priority order is displayed.

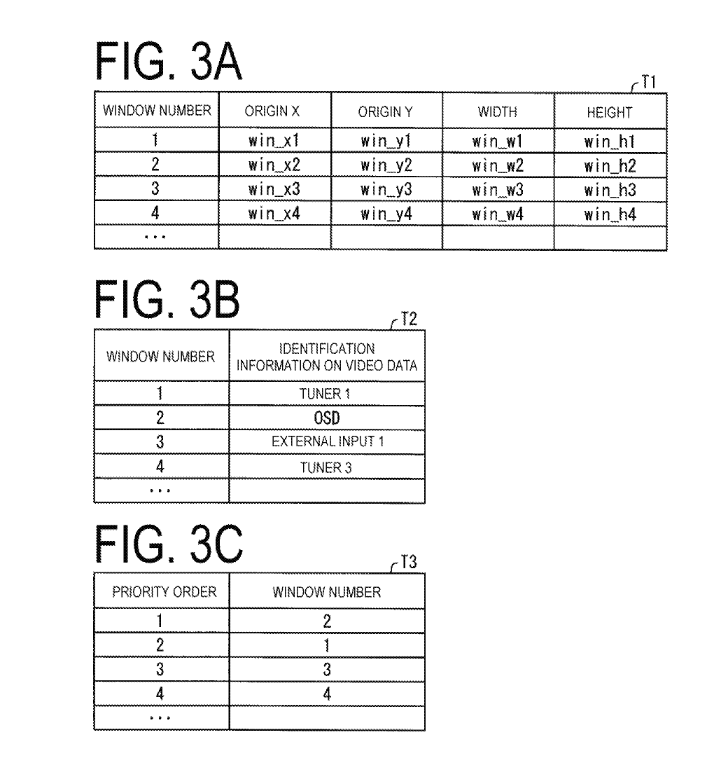

FIGS. 3A to 3C are diagrams illustrating, each in a table format, an example of the window setting information. The window setting information includes a window position table T1, a window content table T2, and a priority order table T3. FIGS. 3A to 3C illustrate the examples of the tables. The window setting unit 20 transmits the window content table T2 out of the window setting information to the reception processing circuit 13, and also transmits the window position table T1 and the priority order table T3 to the video processing circuit 14.

As illustrated in FIG. 3A, the window position table T1 includes the window number and position information and dimensional information for each window W. In the present embodiment, on the basis of the upper left vertex of the screen SC set as an origin, the horizontal direction starting from the origin is set as an x axis direction, and the vertical direction is set as a y axis direction. On the basis of the upper left vertex of each of the windows W set as an origin of the window W, the position information of the window W includes an x coordinate (origin x) and a y coordinate (origin y) at the origin. The dimension information of each window W includes a width (a length in the horizontal direction) and a height (a length in the vertical direction) of the window W.

As illustrated in FIG. 3B, the window content table T2 includes, for each window W, a window number and identification information on the video data processed by the reception processing circuit 13. As illustrated in FIG. 3C, a priority order and a window number are associated in the priority order table T3.

The window setting unit 20 further treats, as a background area BG, a display area other than the display areas in which the windows are set on the screen, and sets a background color for the background area BG. The window setting unit 20 creates background color data conforming to a predetermined color gamut (for example, the color gamut conforming to the display unit 15) with respect to the set background color. Then, the window setting unit 20 sets the predetermined color gamut as background color gamut, and transmits a background color gamut number indicating the background color gamut and the background color data to the video processing circuit 14.

### Detail of Reception Processing Circuit

As illustrated in FIG. 1, the reception processing circuit 13 is constituted to include a multi-tuner unit (acquisition unit) 30, a multi external input unit (acquisition unit) 31, an OSD creation unit (acquisition unit) 32, a display selection unit 33, and a color gamut specifying unit (specifying unit) 34.

The multi-tuner unit 30 is a unit configured to select and receive the plurality of video signals broadcast by various broadcasting media (acquisition step). The multi-tuner unit 30 performs reception processing such as demultiplexing and decoding on the plurality of received broadcast signals to acquire the video data, and supplies the acquired video data to the display selection unit 33. Note that the selection may be made in response to an instruction given by a user via the operation unit 12 and the controller 10, or may be automatically performed in response to an instruction given by the controller 10.

The multi external input unit 31 is a unit configured to receive each of a plurality of AV signals from a plurality of external devices via wireless or wired connection (acquisition step). The multi external input unit 31 performs reception processing such as decoding on the plurality of input AV signals to acquire video data, and supplies the acquired video data to the display selection unit 33.

The OSD creation unit 32 is a unit configured to create an OSD image on the basis of the instruction given by the controller 10 (acquisition step). The OSD creation unit 32 supplies the data of the created OSD image to the display selection unit 33 as video data.

The display selection unit 33 is a unit configured to select a plurality of video data to be used for display out of the plurality of video data supplied by the multi-tuner unit 30, the multi external input unit 31, and the OSD creation unit 32. The display selection unit 33 supplies the plurality of selected video data to the color gamut specifying unit 34.

Specifically, the display selection unit 33 first stores the window content table T2 supplied by the window setting unit 20 of the controller 10 in registers (not illustrated), and selects the video data specified on the basis of the identification information included in the window content table T2. In the case of FIG. 2, the display selection unit 33 selects four types of video data.

In the present embodiment, the display selection unit 33 outputs, by referring to the window content table T2, the video data corresponding to the window number from a port corresponding to the window number. This allows a downstream block to specify the window number depending on a port from which image data are input, and thus to specify the window in which the image indicated by the image data is displayed.

The color gamut specifying unit 34 is a unit configured to specify the color gamut to which each of the video data conforms, for each of the plurality of video data supplied by the display selection unit 33 (specifying step). The color gamut specifying unit 34 supplies, for each of the video data, a color gamut number for identification of the specified color gamut together with the video data to the video processing circuit 14.

Specifically, the color gamut specifying unit 34 specifies a standard which includes color gamut specifications and to which each of the video data supplied by the display selection unit 33 conforms, and supplies the color gamut number associated with the specified standard to the video processing circuit 14. Examples of the standard including color gamut specifications include video standards such as BT.709 standard, BT.2020 standard, National Television System Committee (NTSC) standard, and Digital Cinema Initiatives (DCI) standard, and color space standards such as sRGB standard, and Adobe RGB standard.

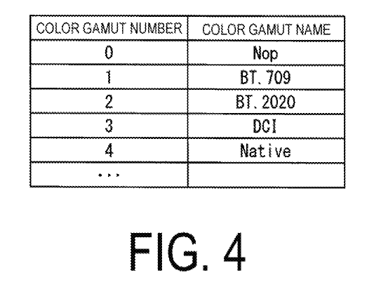

FIG. 4 is a diagram illustrating, in a table format, an example of a color gamut identification table in which a color gamut number and a color gamut name are associated. The color gamut name includes a standard name including the color gamut specifications, “Nop,” and “Native.” The term of “Nop” is a color gamut name for a background. The term of “Native” is a name of a color gamut set inside the TV receiver 1. In the illustrated example, the gamut number 0 is associated with “Nop;” the gamut number 1 is associated with BT.709 standard; the color gamut number 2 is associated with BT.2020 standard; the color gamut number 3 is associated with DCI standard; and the color gamut number 4 is associated with “Native.”

In the case where the video data include identification information of the standard, the color gamut specifying unit 34 may extract identification information of the standard from the video data.

In the case of a broadcast signal through terrestrial digital broadcasting, BS broadcasting, or CS broadcasting, the multi-tuner unit 30 is capable of specifying the BT.709 standard or the BT.2020 standard depending on the selected channel number. Accordingly, in the case described above, the color gamut specifying unit 34 may receive the identification information of the standard specified by the multi-tuner unit 30.

In the case of Internet broadcasting, the BT.709 standard identical to the standard for high-vision broadcasting is used generally. Accordingly, in the case of the broadcast signal in Internet broadcasting, the multi-tuner unit 30 may specify the BT.709 standard. Alternatively, when the standard is set by default in the software for reproducing a broadcast signal of the Internet broadcasting, the multi-tuner unit 30 may use the standard set by default.

In the case of photographing data picked up by a digital camera, the multi external input unit 31 is capable of specifying the standard by extracting a color profile from the photographing data. In the case of being connected to an external device on the basis of the High-Definition Multimedia Interface (HDMI) standard, the multi external input unit 31 is capable of specifying the standard on the basis of additional information (AVI InfoFrame packet) transmitted in a blank period (Data Island Period) between transmission timings of the video data to be transmitted by the external device. Accordingly, in the case described above, the color gamut specifying unit 34 may receive the identification information of the standard specified by the multi external input unit 31.

Note that some of the video data received by the multi-tuner unit 30 and the multi external input unit 31 may be the video data for which the standard cannot be specified. In this case, it is appropriate that the multi-tuner unit 30 and the multi external input unit 31 determines the standard as the BT.709 standard which is currently commonly used as the standard for color gamut specifications.

### Detail of Image Processing Circuit

As illustrated in FIG. 1, the video processing circuit 14 is constituted to include a window processing unit (conversion unit) 40 and a color gamut adjustment unit (conversion unit) 41.

The window processing unit 40 is a unit configured to convert the plurality of video data supplied by the color gamut specifying unit 34 into a single unit of multi-video data indicating multi video including the plurality of video images each indicated by the plurality of video data on one screen (conversion step). The window processing unit 40 is a unit configured to further create a color gamut map in which a pixel position and a color gamut number are associated with each other on the basis of the plurality of color gamut numbers supplied by the color gamut specifying unit 34. The window processing unit 40 supplies the converted multi-video data and the created color gamut map to the color gamut adjustment unit 41.

The color gamut adjustment unit 41 is a unit configured to adjust the pixel data for each pixel included in the multi-video data by using the multi-video data and the color gamut map supplied by the window processing unit 40, so that the pixel data conform to the color gamut of the display unit 15 (conversion step). The color gamut adjustment unit 41 supplies the data including the adjusted pixel data for each pixel as the display data to the display unit 15.

### Detail of Window Processing Unit

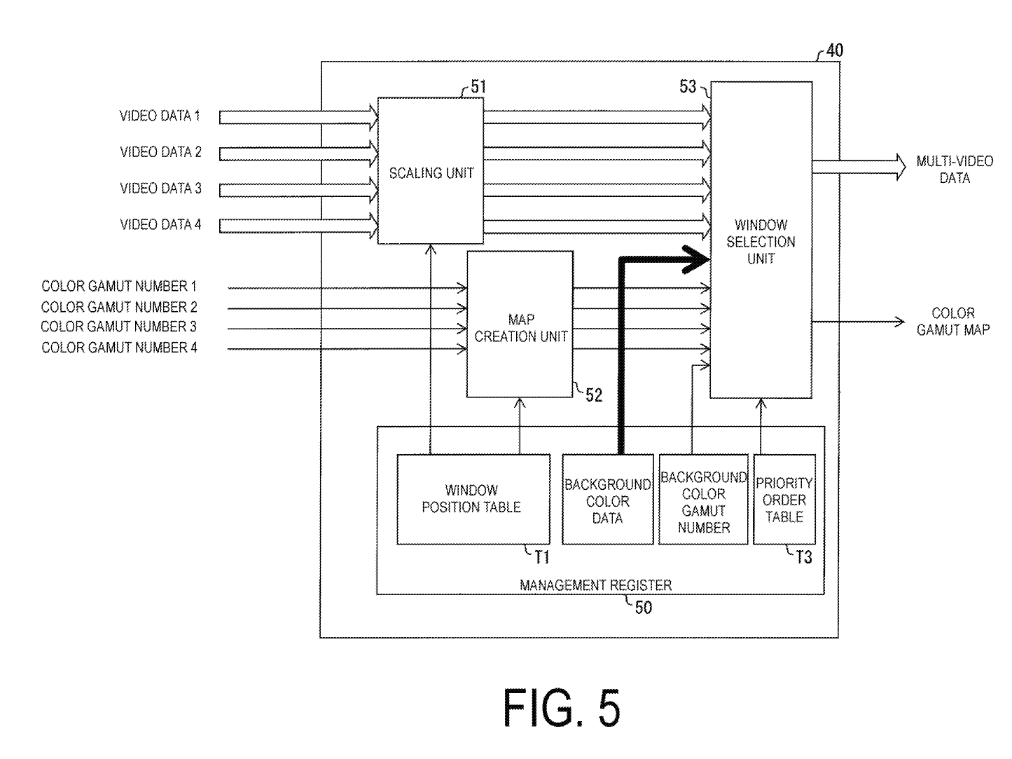

FIG. 5 is a block diagram illustrating the schematic constitution of the window processing unit 40. As illustrated, in the figure, the window processing unit 40 is constituted to include a management register 50, a scaling unit 51, a map creation unit (creation unit) 52, and a window selection unit 53.

The management register 50 stores the window position table T1, the priority order table T3, the background color data and the background color gamut information transmitted by the window setting unit 20 of the controller 10.

The scaling unit 51 is a unit configured to enlarge or reduce a size of each of the plurality of video data supplied by the color gamut specifying unit 34 by referring to the window position table T1 in the management register 50, so that the video indicated by the video data conforms to the size of the corresponding window. The scaling unit 51 creates the window video data indicating such window video in which the enlarged or reduced video in size is set at the position of the corresponding window. Note that the window video data include meaningless data (for example, null data) for an area other than the corresponding windows. The scaling unit 51 supplies the plurality of created window video data to the window selection unit 53.

The map creation unit 52 is a unit configured to create a window color gamut map in which each of the plurality of color gamut numbers supplied by the color gamut specifying unit 34 is included in the corresponding window, by referring to the window position table T1 in the management register 50. Note that the window color gamut map includes a color gamut number 0 associated with “Nop” for an area other than the corresponding windows. The map creation unit 52 supplies the plurality of created window color gamut maps to the window selection unit 53.

The window selection unit 53 is a unit configured to make a selection out of the plurality of window video data supplied by the scaling unit 51 on the basis of the priority order table T3 in the management register 50, to create the multi-video data. The window selection unit 53 supplies the created multi-video data to the color gamut adjustment unit 41.

Specifically, with regard to a certain pixel, the window selection unit 53 first selects the window video data of the window having the highest priority (window number 2), and adopts the selected window video data in the case where the data of the pixel included in the selected window video data are significant data. On the other hand, in the case where the data of the pixel are meaningless data, the window selection unit 53 selects the window video data of the window having the next highest priority (window number 1), and then repeats the operation. In the case where all of the data of the pixel included in all of the window video data are meaningless data, the pixel is considered as being included in the background area, and thus the data of the background color are selected. As a result, the data of the pixel included in the multi-video data are determined. Repeating of the operation for all of the pixels allows the creation of the multi-video data.

The window selection unit 53 is a unit configured to make a selection out of the plurality of window color gamut maps supplied by the map creation unit 52 on the basis of the priority order table T3 in the management register 50, to create the color gamut map. The window selection unit 53 supplies the created color gamut map to the color gamut adjustment unit 41.

Specifically, with regard to a certain pixel, the window selection unit 53 first selects the window color gamut map of the window having the highest priority (window number 2), and adopts the color gamut number of the pixel included in the selected window color gamut map in the case where the color gamut number is not 0 (background color gamut number). On the other hand, in the case where the color gamut number of the pixel is 0, the window selection unit 53 selects the window color gamut map of the window having the next highest priority (window number 1), and then repeats the operation. In the case where all of the color gamut numbers of the pixel included in all of the window color gamut maps are 0, the pixel is considered as being included in the background area, and thus the color gamut number of 0 is adopted. As a result, the color gamut number of the pixel included in the color gamut map is determined. Repeating of the operation for all of the pixels allows the creation of the color gamut map.

### Outline of 3D-LUT

As described above, the color gamut adjustment unit 41 is a unit configured to adjust the pixel data for each pixel included in the multi-video data supplied by the window processing unit 40, so that the pixel data conform to the color gamut of the display unit 15. In the present embodiment, a 3 Dimension-Look Up Table (3D-LUT) is used in the adjustment.

First, the outline of the 3D-LUT (table) will be described. In a general TV system, a color management system is installed so that the TV receiver 1 expresses the same colors as or more vivid colors than the colors picked up by a camera.

The video signal picked up by a camera is broadcast after being converted into the video data conforming to the color gamut defined by a predetermined standard (for example, BT.709 standard), and received by the TV receiver 1. To the video signal picked up by a camera, 1/2.2 gamma characteristic has been added. Accordingly, in the input stage in the color management system, the received video data are subjected to de-gamma processing to be converted into linear data easily available for calculation. The linear data can be obtained through calculation by multiplying 2.2 gamma characteristic corresponding to the reciprocal of 1/2.2.

The video data converted into the linear data are subjected to color conversion processing by use of a Look Up Table (LUT). The 3D-LUT is a table for performing of the color conversion processing using three signal data of RGB. In the 3D-LUT, the input RGB numerical values are converted into appropriate values for display in the display unit 15. That is, the color information (R, G, B) input by a camera is subjected to coordinate conversion processing so as to be converted into the color information (R′, G′, B′) which is available to reproduce on a display the same colors as those of the input color information. This makes it possible to reduce or minimize the difference between the input/output characteristics of the camera and the display.

The linear data subjected to the color conversion processing are then subjected to re-gamma processing to be converted into gamma curve data conforming to the gamma characteristics of the display unit 15. This processing can correct variations for each of the display unit 15. Note that the conversion table used for the re-gamma processing is created in advance so that the relation between input voltage and luminance becomes linear.

Note that, in the case where the output values for all of the input values of RGB are defined in the case of the 3D-LUT, a large amount of data are required, which is not realistic. Accordingly, a 3D-LUT relating to some representative input values is first prepared, and then output values with respect to the representative input values are determined by use of the 3D-LUT; however, input values other than the representative input values (unstored values) are subjected to interpolation processing for calculation. Note that the intervals between the several representative input values are not uniform. This is because, due to visual characteristics of human, visual sensitivity is high in dark tones hut low in bright tones. Since a slight error in bright tones is allowable, the intervals in bright tones can be widened. This makes it possible to further reduce data amount in the 3D-LUT.

As described above, the 3D-LUT provides, previously in a table form, the output coordinates of R′, G′, B′ for display in the display unit 15 in the same colors with respect to the input coordinates of RGB serving as representative points, through measurement and determination. A case of RGB in tones from 0 to 255 is now considered as an example. In this case, eight points of 0, 8, 16, 24, 48, 64, 128 and 255 are set as representative points.

The R′G′B′ coordinates to be actually set in a display are measured with respect to all of the combinations of the color coordinates of (R, G, B) including (0, 0, 0), (8, 0, 0), . . . , (8, 8, 8), (16, 8, 8), (8, 16, 8), . . . , (255, 255, 128), and (255, 255, 255). Thereby, the combinations of the color coordinates of (R′, G′, B′) including (0, 0, 0), (10, 0, 0), . . . , (10, 10, 10), (20, 10, 10), (10, 20, 10), . . . , (255, 255, 136), (255, 255, 255) are set. In an example, when the coordinate of (R′, G′, B′) equal to (20, 10, 10) is output in response to the coordinate of (R, G, B) equal to (16, 8, 8) being input, the same color is expressed in the display unit 15. All such results of measurement are recorded to create a one-to-one representative point table. With reference to the representative point table completed in this manner, an output coordinate in response to any input coordinate is obtained through calculation in the interpolation processing.

In the present embodiment, the 3D-LUT described above is prepared for each different color gamut.

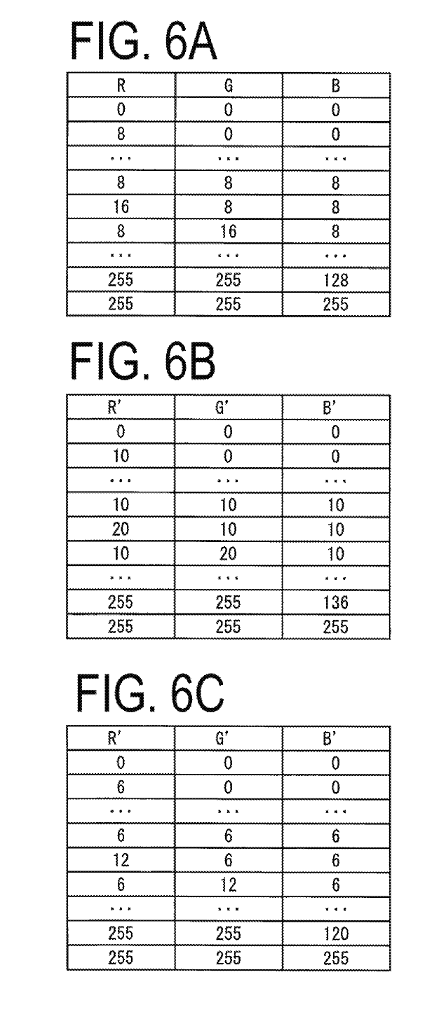

FIGS. 6A to 6C are diagrams illustrating for each different color gamut the R′G′B′ coordinates to be output in response to the input RGB coordinates, with respect to the 3D-LUT, FIG. 6A illustrates, in a table format, representative points of RGB coordinates to be input, and FIG. 613 and FIG. 6C illustrate, in table formats, the R′G′B′ coordinates to be output in response to the representative points respectively in the case of the BT.709 standard and the case of the BT.2020 standard. It is understood that, with reference to the figures, the R′G′B′ coordinates to be output differ depending on the color gamut even when the same RGB coordinate is input.

### Detail of Color Gamut Conversion Unit

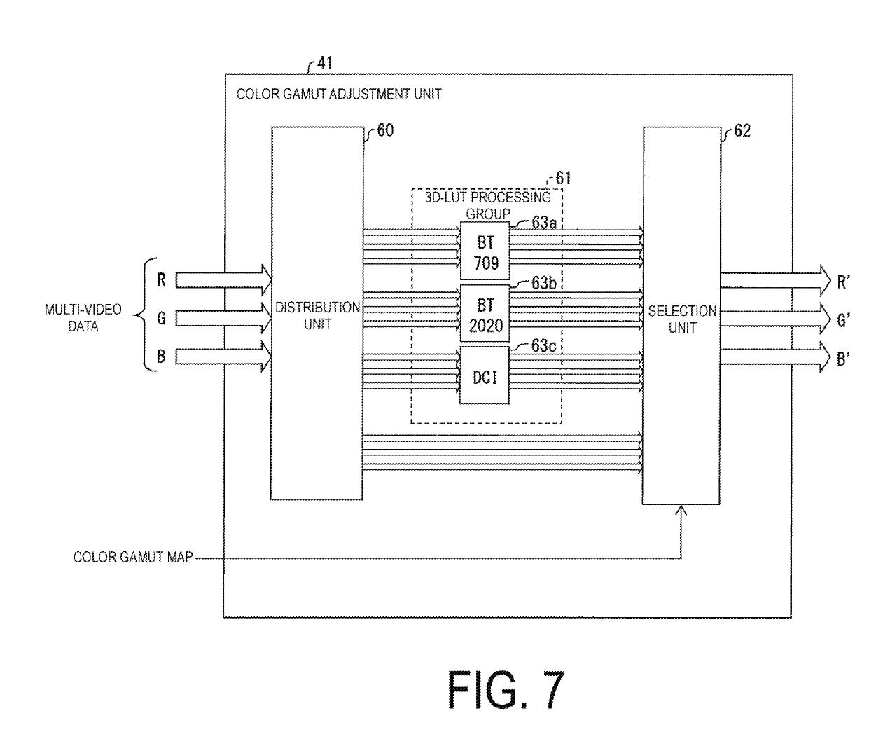

FIG. 7 is a block diagram illustrating the schematic constitution of the color gamut adjustment unit 41. As illustrated in the figure, the color gamut adjustment unit 41 is constituted to include a distribution unit 60, a 3D-LUT processing group 61, and a selection unit 62. In the illustrated example, the 3D-LUT processing group 61 includes a 3D-LUT processing unit 63a, a 3D-LUT processing unit 63b, and a 3D-LUT processing unit 63c, which are storage devices, having different 3D-LUTs each conforming to the BT.709 standard, the BT.2020 standard and the DCI standard. That is, in the present embodiment, three units of 3D-LUT processing units 63a to 63c are mounted in parallel.

The distribution unit 60 performs de-gamma processing on RGB data for one pixel of the multi-video data supplied by the window processing unit 40, and distributes the resultant RGB linear data to the selection unit 62, and the 3D-LUT processing units 63a to 63c.

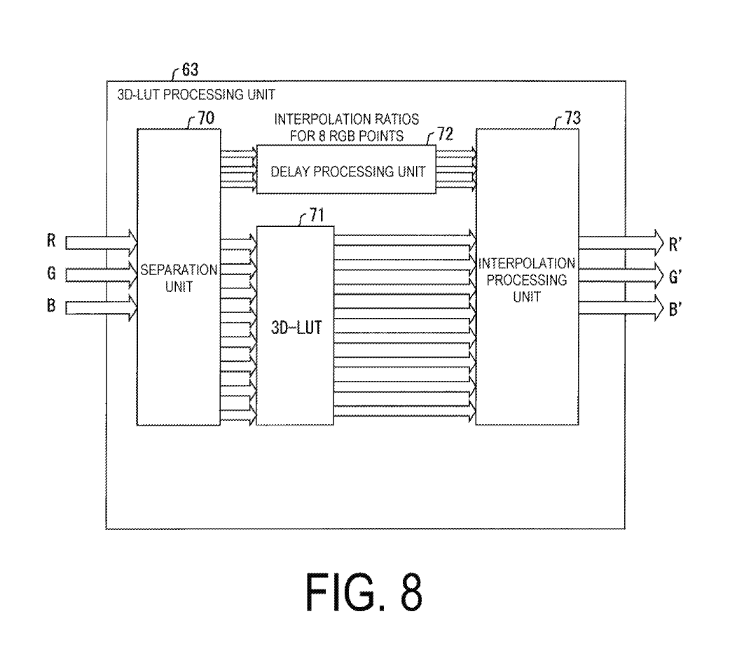

FIG. 8 illustrates the schematic constitution of the 3D-LUT processing unit 63 used in the color gamut adjustment unit 41. As illustrated in the figure, the 3D-LUT processing unit 63 is constituted to include a separation unit 70, a 3D-LUT (storage device) 71, a delay processing unit 72, and an interpolation processing unit 73.

The separation unit 70 is a unit configured to separate the input RGB linear data into eight representative points of RGB coordinates and three interpolation ratios. The separation unit 70 supplies the eight representative points of RGB coordinates to the 3D-LUT 71, and also supplies the three interpolation ratios to the delay processing unit 72.

The representative points are provided so as to make lattice shapes on a RGB coordinate space. Therefore, the eight representative points corresponding to lattice points are adjacent to each other to coordinate points on the RGB coordinate space indicated by the RUB linear data. The interpolation ratio serves as an interpolation ratio for each of an R coordinate, a G coordinate and a B coordinate. Note that, since the method of calculating the interpolation ratio is well known, the detail thereof is omitted.

The 3D-LUT 71 is a unit configured to output the eight R′G′B′ coordinates conforming to the color gamut of the display unit 15 to the interpolation processing unit 73 on the basis of the eight representative points of the RUB coordinates input by the separation unit 70.

The delay processing unit 72 is a unit configured to delay supplying, to the interpolation processing unit 73, of the three interpolation ratios supplied by the separation unit 70, by a processing time in the 3D-LUT 71.

The interpolation processing unit 73 is a unit configured to perform interpolation processing by using the eight R′G′B′ coordinates output by the 3D-LUT 71 and the three interpolation ratios supplied by the delay processing unit 72, so as to obtain through calculation the R′G′B′ linear data conforming to the color gamut of the display unit 15 with respect to the RGB linear data. The interpolation processing unit 73 supplies the calculated R′G′B′ linear data to the selection unit 62.

The selection unit 62 is a unit configured to select one of the three sets of R′G′B′ linear data supplied by the 3D-LUT processing units 63a to 63c and the RGB linear data supplied by the distribution unit 60 on the basis of the color gamut map supplied by the window processing unit 40. The selection unit 62 performs re-gamma processing on the selected RGB linear data or the selected R′G′B′ linear data, and supplies the result to the display unit 15 as display data.

Specifically, in the case where the color gamut number corresponding to the pixel position of RGB data for one pixel is 1, the selection unit 62 selects the R′G′B′ linear data supplied by the 3D-LUT processing unit 63a relating to the BT.709 standard, by referring to the color gamut map. In the case where the color gamut number is 2, the selection unit 62 selects R′G′B′ linear data supplied by the 3D-LUT processing unit 63b relating to the BT.2020 standard. In the case where the color gamut number is 3, the selection unit 62 selects the R′G′B′ linear data supplied by the 3D-LUT processing unit 63c relating to the DCI standard,

In the case where the color gamut number is 0 (NOP) or 4 (Native), the selection unit 62 selects the RGB linear data supplied by the distribution unit 60. That is, in this case, the color gamut adjustment by the 3D-LUTs is ignored (not implemented).

### Second Embodiment

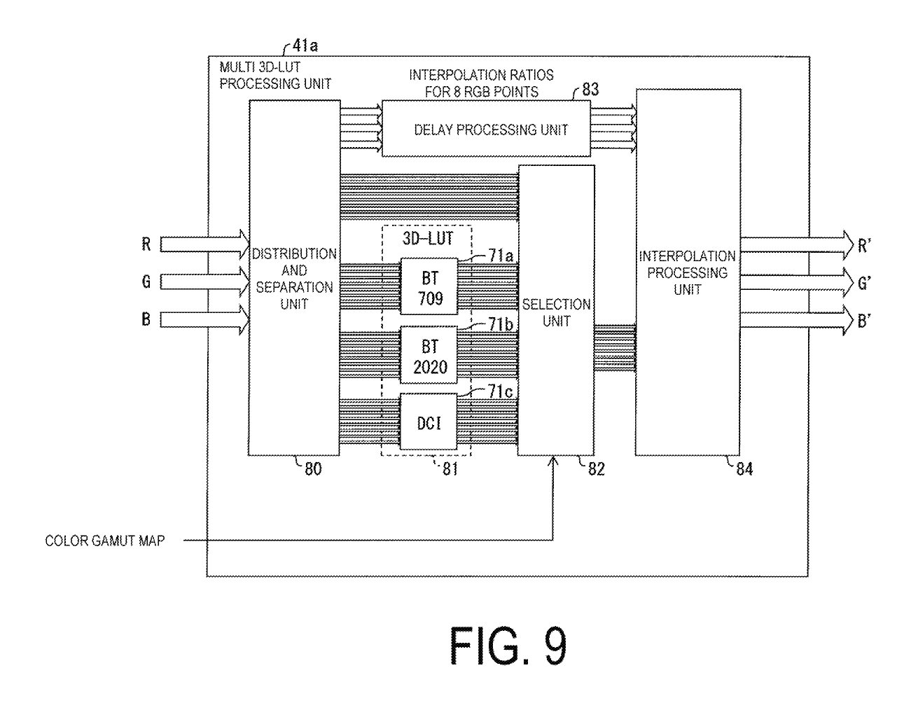

Another embodiment of the present invention will be described with reference to FIG. 9.

FIG. 9 is a block diagram illustrating the schematic constitution of the color gamut adjustment unit 41 in the video processing circuit 14 of the TV receiver 1 according to the present embodiment. As illustrated in the figure, a color gamut adjustment unit (conversion unit) 41a is constituted to include a distribution and separation unit 80, a 3D-LUT group 81, a selection unit 82, a delay processing unit 83, and an interpolation processing unit 84. In the illustrated example, the 3D-LUT group 81 includes different units of a 3D-LUT 71a, a 3D-LUT 71b, and a 3D-LUT 71c (refer to FIG. 8) respectively conforming to the BT.709 standard, the BT.2020 standard and the DCI standard. That is, in the present embodiment, three units of 3D-LUTs 71a to 71c are mounted in parallel.

The distribution and separation unit 80 is constituted with the combination of the distribution unit 60 illustrated in FIG. 7 and the separation unit 70 illustrated in FIG. 8. That is, the distribution and separation unit 80 performs de-gamma processing on RGB data for one pixel of the multi-video data supplied by the window processing unit 40, and separates the resultant RGB linear data into eight representative points of RGB coordinates and three interpolation ratios. The distribution and separation unit 80 supplies the eight representative points of RGB coordinates to the selection unit 82 and the 3D-LUTs 71a to 71c, and also supplies the three interpolation ratios to the delay processing unit 83.

The selection unit 82 is a unit configured to select one of the eight R′G′B′ coordinates each output by the 3D-LUTs 71a to 71c and the eight RGB coordinates supplied by the distribution and separation unit 80 on the basis of the color gamut map supplied by the window processing unit 40. The selection unit 82 supplies the selected eight RGB coordinates or the selected eight R′G′B° coordinates to the interpolation processing unit 84. Note that the specific selection method in the selection unit 82 is the same as the selection method in the selection unit 62 illustrated in FIG. 7, and thus the description thereof is omitted.

The delay processing unit 83 is a unit configured to delay supplying, to the interpolation processing unit 84, of the three interpolation ratios supplied by the distribution and separation unit 80, by a processing time in the 3D-LUTs 71a to 71c and a processing time in the selection unit 82,

The interpolation processing unit 84 is a unit configured to perform interpolation processing by using the eight RGB coordinates or the eight R′G′B′ coordinates supplied by the selection unit 82 and the three interpolation ratios supplied by the delay processing unit 83, so as to obtain through calculation the R′G′B′ linear data or the RGB linear data conforming to the color gamut of the display unit 15. The interpolation processing unit 84 performs re-gamma processing on the calculated RGB linear data or the calculated R′G′B′ linear data, and supplies the result to the display unit 15 as display data.

The color gamut adjustment unit 41a of the present embodiment is capable of exhibiting the same effects as those of the color gamut adjustment unit 41 illustrated in FIG. 7 and FIG. 8.

The color gamut adjustment unit 41 illustrated in FIG. 7 and FIG. 8 includes three 3D-LUT processing units 63a to 63c, and thus includes three interpolation processing units 73. Contrarily, the color gamut adjustment unit 41a of the present embodiment only needs to include one interpolation processing unit 84. This makes it possible to reduce the number of interpolation processing units each requiring complicated multiplying circuits, and thus downsize the circuit, as a result.

### Third Embodiment

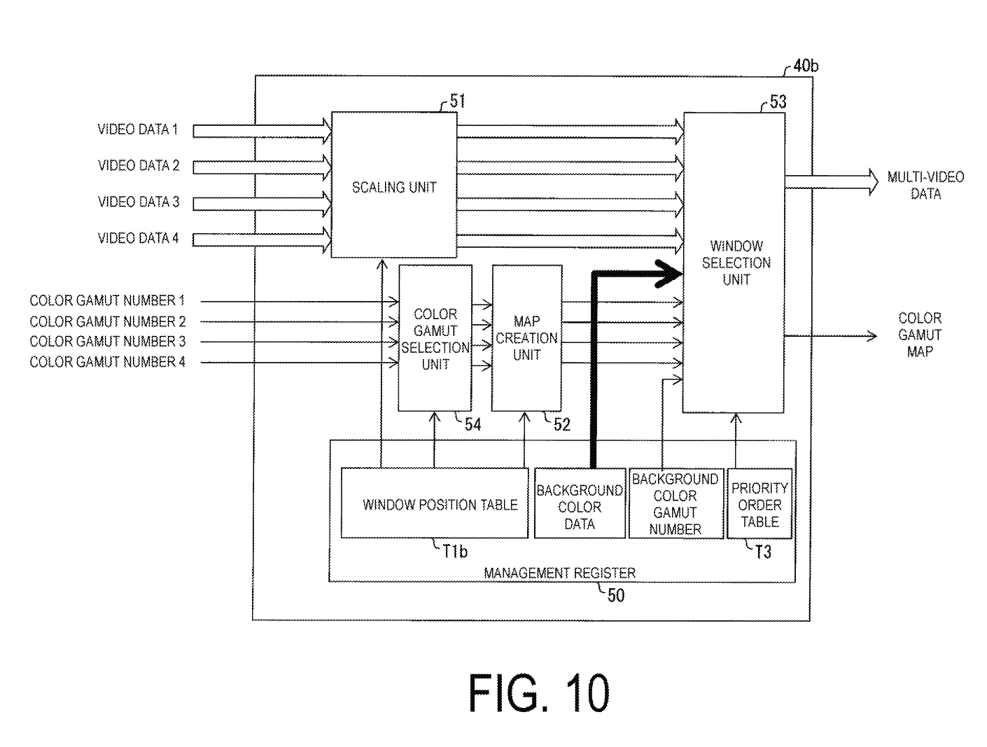

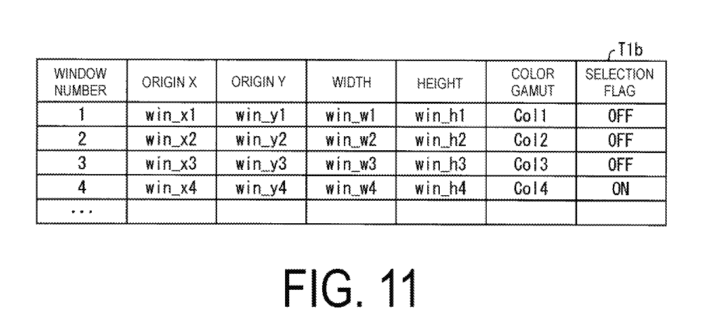

Other embodiment according to the present invention will be described with reference to FIG. 10 and FIG. 11. In the present embodiment, a user can set a color gamut to which the video data indicating video for display on each window conform. The present embodiment is suitable when the color gamut specifying unit 34 cannot automatically specify a color gamut to which the video data conform.

FIG. 10 is a block diagram illustrating a schematic constitution of a window processing unit (conversion unit) 40b in the video processing circuit 14 of the TV receiver 1 according to the present embodiment. The window processing unit 40b according to the present embodiment is constituted to, unlike the window processing unit 40 illustrated in FIG. 5, include a window position table T1b instead of the window position table T1 and additionally include a color gamut selection unit 54, and further include others identical to those of the window processing unit 40.

FIG. 11 is a diagram illustrating, in a table format, an example of the window position table T1b. The window position table T1b illustrated in FIG. 11 additionally includes, unlike the window position table T1 illustrated in FIG. 3A, a color gamut number and a selection flag for each window number, and further includes others identical to those of the window position table T1.

The color gamut number is a number to be set by a user via the operation unit 12 and the window setting unit 20 of the controller 10. The selection flag is a flag for indicating which is to be selected between the color gamut number supplied by the color gamut specifying unit 34 of the reception processing circuit 13 and the color gamut number read out from the window position table T1b in the management register 50.

The color gamut selection unit 54 is disposed upstream from the map creation unit 52, and is a unit configured to select one of the color gamut number supplied by the color gamut specifying unit 34 of the reception processing circuit 13 and the color gamut number read out from the window position table T1b in the management register 50, on the basis of the selection flag in the window position table T1b. Specifically, in the case where the selection flag is ON, the color gamut selection unit 54 selects the color gamut number read out from the window position table T1b. In the case where the selection flag is OFF, the color gamut number supplied by the color gamut specifying unit 34 is selected. The color gamut selection unit 54 supplies the selected color gamut number to the map creation unit 52.

### Additional Notes

Note that the TV receiver 1 may be disposed along with an external display device instead of the display unit 15. In this case, the TV receiver 1 is preferably connected to the external display device on the basis of the HDMI standard. In this case, receiving of Extended Display Identification Data (EDID) from the external display device makes it possible to grasp the color gamut supported by the external display device.

### Realization Example by Software

A control block (in particular, the controller 10) of the TV receiver 1 may be realized by a logic circuit (hardware) formed in an integrated circuit (IC chip) and the like, or by software by using Central Processing Unit (CPU),

In the latter case, the TV receiver 1 includes CPU configured to execute a command of a program, that is software, to realize each function, Read Only Memory (ROM) or a storage device (these are referred to as “recording medium”) configured to store the program and various types of data in a manner capable of being read by a computer (or CPU), Random Access Memory (RAM) to develop the program, and the like. Then, when the computer (or CPU) reads the program from the recording medium and executes the program, an object of the present invention is achieved. As the recording medium, a “non-temporarily concrete medium” such as, a tape, a disk, a card, a semiconductor memory, or a programmable logic circuit may be used. Further, the program may be supplied to the computer via any transmission medium (communication network, a broadcast wave, and the like) capable of transmitting the program. Note that the present invention may be realized in a mode of a data signal embodied by electronically transmitting the program, where the data signal is embedded in a carrier wave.

### SUMMARY

The image processing apparatus (reception processing circuit 13, video processing circuit 14) of the first aspect of the present invention is configured to perform image processing on image data, and is constituted to include an acquisition unit (multi-tuner unit 30, multi external input unit 31, OSD creation unit 32) and a conversion unit (window processing unit 40, color gamut adjustment unit 41), and further includes a specifying unit (color gamut specifying unit 34). The acquisition unit is configured to acquire a plurality of image data. The conversion unit is configured to convert the plurality of image data acquired by the acquisition unit into display data including a plurality of images each indicated by the plurality of image data. The plurality of images are to be displayed on one screen of a display device (display unit 15). The specifying unit is configured to specify a color gamut. Each of the plurality of image data conforms to the color gamut. The conversion unit converts the plurality of image data into the display data conforming to a color gamut of the display device on the basis of the color gamut specified by the specifying unit.

According to the constitution, the plurality of image data are acquired, and the plurality of acquired image data are converted into the display data. On the basis of the display data, the display device is capable of displaying the plurality of images each indicated by the plurality of image data on one screen. Further, according to the constitution, the color gamut to which each of the plurality of image data conforms is specified, and the plurality of image data are converted to the display data conforming to the color gamut of the display device on the basis of the specified color gamut. Accordingly, even when the plurality of image data having different color gamuts are acquired, the display device is capable of displaying the plurality of images each in the same colors as or colors close to those of original images.

The image processing apparatus of the second aspect of the present invention, according to the first aspect, further includes a storage device (management register 50) and a creation unit (map generation unit 52). The storage device is configured to store an image map including an area on the screen and identification information on an image to be displayed in the area. The area on the screen and the identification information on the image are associated. The creation unit is configured to create a color gamut map including the area on the screen and identification information on the color gamut specified by the specifying unit with respect to each of the plurality of image data indicating the image to be displayed in the area, by using the image map. The area on the screen and the identification information on the color gamut are associated. The conversion unit may convert the plurality of image data into the display data by using the image map and the color gamut map. In this case, the image data indicating the image to be displayed and the color gamut to which the image data conform can be specified, for each pixel on the screen. Accordingly, the plurality of image data can be converted into the display data conforming to the color gamut of the display device for each pixel.

The image processing apparatus of the third aspect of the present invention, according to the second aspect, further includes a storage device (3D-LUT processing units 63a to 63c) configured to previously store, for each color gamut, a table (3D-LUT) for conversion of values of image data conforming to a certain color gamut into values of image data conforming to the color gamut of the display device. The conversion unit may convert the plurality of image data into the display data by using the table corresponding to the color gamut specified by the specifying unit. In this case, the conversion can be performed speedily.

In the image processing apparatus of the fourth aspect of the present invention, according to the third aspect, the table stores some of the values of the image data conforming to the certain color gamut, and the conversion unit is preferably configured to convert the plurality of image data into the display data by performing interpolation processing on a value not stored in the table. In this case, data amount of the table stored in the storage device can be reduced.

In the image processing apparatus of the fifth aspect of the present invention, according to the fourth aspect, the conversion unit may convert the plurality of image data into the display data by using the values stored in the table, and may perform the interpolation processing on the display data that is converted. In this case, the circuit constitution required in the interpolation processing can be reduced because the interpolation processing is not required for each of the tables.

In the image processing apparatus of the sixth aspect of the present invention, according to the first aspect to the fifth aspect, the specifying unit may specify, according to a user, at least one of a plurality of the color gamuts. The plurality of image data conform to the plurality of color gamuts. This is suitable when the specifying unit cannot automatically specify a color gamut to which the image data conform.

In the image processing apparatus of the seventh aspect of the present invention, according to the first aspect to the sixth aspect, the specifying unit may specify the color gamut by specifying a standard including color gamut specifications to which each of the plurality of image data conforms. Examples of the standard including the color gamut specifications include video standards and color space standards as descried above.

An integrated circuit of image processing of the eighth aspect of the present invention is an integrated circuit configured to performs image processing on image data, and includes a logic circuit. The logic circuit functionally includes an acquisition unit and a conversion unit, and further functionally includes a specifying unit. The acquisition unit is configured to acquire a plurality of image data. The conversion unit is configured to convert the plurality of image data acquired by the acquisition unit into display data including a plurality of images each indicated by the plurality of image data. The plurality of images are to be displayed on one screen of a display device. The specifying unit is configured to specify a color gamut. Each of the plurality of image data conforms to the color gamut. The conversion unit converts the plurality of image data into the display data conforming to a color gamut of the display device on the basis of the color gamut specified by the specifying unit.

According to the constitution, effects similar to those in the first aspect can be exhibited.

A method for controlling an image processing apparatus of the ninth aspect of the present invention is a method for controlling an image processing apparatus configured to perform image processing on image data, and includes the steps of acquiring a plurality of image data, and converting the plurality of image data acquired in the step of acquiring into display data including a plurality of images each indicated by the plurality of image data. The plurality of images are to be displayed on one screen of a display device. The method further includes the step of specifying a color gamut. Each of the plurality of image data conforms to the color gamut. The step of converting includes conversion of the plurality of image data into the display data conforming to a color gamut of the display device on the basis of the color gamut specified in the specifying.

According to the method, effects similar to those in the first aspect can be exhibited.

An image processing apparatus of each aspect of the present invention may be realized by a computer. In this case, a control program of the image processing apparatus and a computer-readable recording medium fall within the scope of the present invention. The control program is configured to realize, by a computer, the image processing apparatus by operating the computer as each unit provided in the image processing apparatus. The computer-readable recording medium is configured to store the control program.

The present invention is not limited to each of the-described embodiments. It is possible to make various modifications within the scope of the claims. An embodiment obtained by appropriately combining technical elements each disclosed in different embodiments falls also within the technical scope of the present invention. Further, when technical elements disclosed in the respective embodiments are combined, it is possible to form a new technical feature.

### INDUSTRIAL APPLICABILITY

In the present invention, the color gamut to which each of the plurality of image data conforms is specified, and the plurality of image data are converted into the display data conforming to the color gamut of the display device on the basis of the specified color gamut. Thus, even when the plurality of image data having different color gamuts are acquired, the display device displays the plurality of images each in the same colors as or colors close to those of original images. Accordingly, the present invention is applicable to any image processing device configured to display a plurality of images in one screen.

### REFERENCE SIGNS LIST

1 TV receiver
10 Controller
11 Storage unit
12 Operation unit
13 Reception processing circuit (image processing apparatus)
14 Video processing circuit (image processing apparatus)
15 Display unit (display device)
20 Window setting unit
30 Multi-tuner unit (acquisition unit)
31 Multi external input unit (acquisition unit)
32 OSD creation unit (acquisition unit)
33 Display selection unit
34 Color gamut specifying unit (specifying unit)
40, 40b Window processing unit (conversion unit)
41, 41a Color gamut adjustment unit (conversion unit)
50 Management register (storage device)
51 Scaling unit
52 Map creation unit (creation unit)
53 Window selection unit
54 Color gamut selection unit
60 Distribution unit
61 3D-LUT processing group
62 Selection unit
63, 63a to 63c 3D-LUT processing unit (storage device)
70 Separation unit
71, 71a to 71c 3D-LUT (storage device)
72 Delay processing unit
73 Interpolation processing unit
80 Distribution and separation unit
81 3D-LUT group
82 Selection unit.
83 Delay processing unit
84 Interpolation processing unit

1. An image processing apparatus configured to perform image processing on image data, the image processing apparatus comprising:
an acquisition unit configured to acquire a plurality of image data;
a conversion unit configured to convert the plurality of image data acquired by the acquisition unit into display data including a plurality of images each indicated by the plurality of image data, the plurality of images being to be displayed on one screen of a display device; and
a specifying unit configured to specify a color gamut, each of the plurality of image data conforming to the color gamut, wherein
the conversion unit converts the plurality of image data into the display data conforming to a color gamut of the display device on the basis of the color gamut specified by the specifying unit.

2. The image processing apparatus according to claim 1 further comprising:
a storage device configured to store an image map including an area on the screen and identification information on an image to be displayed in the area, the area on the screen and the identification information on the image being associated; and
a creation unit configured to, by using the image map, create a color gamut map including the area on the screen and the identification information on the color gamut specified by the specifying unit with respect to each of a plurality of image data indicating an image to be displayed in the area, the area on the screen and the identification information on the color gamut being associated, wherein
the conversion unit converts the plurality of image data into the display data by using the age map and the color gamut map.

3. The image processing apparatus according to claim 2 further comprising:
a storage device configured to previously store, for each color gamut, a table for conversion of values of image data conforming to a certain color gamut into values of image data conforming to the color gamut of the display device, wherein
the conversion unit converts the plurality of image data into the display data by using the table corresponding to the color gamut specified by the specifying unit.

4. The image processing apparatus according to claim 3, wherein
the table stores some of the values of the image data conforming to the certain color gamut, and
the conversion unit converts the plurality of image data into the display data by performing interpolation processing on a value not stored in the table.

5. The image processing apparatus according to claim 4, wherein
the conversion unit converts the plurality of image data into the display data by using the values stored in the table, and performs the interpolation processing on the display data that is converted.

6. The image processing apparatus according to claim 1, wherein
the specifying unit specifies, according to a user, at least one of a plurality of the color gamuts, the plurality of image data conforming to the plurality of color gamuts.

7. The image processing apparatus according to claim 1, wherein
the specifying unit specifies the color gamut by specifying a standard including color gamut specifications, each of the plurality of image data conforming to each standard.

8. An integrated circuit of image processing configured to perform image processing on image data, the integrated circuit comprising a logic circuit formed in the integrated circuit, the logic circuit functionally comprising:
an acquisition unit configured to acquire a plurality of image data;
a conversion unit configured to convert the plurality of image data acquired by the acquisition unit into display data including a plurality of images each indicated by the plurality of image data, the plurality of images being to be displayed on one screen of a display device; and
a specifying unit configured to specify a color gamut, each of the plurality of image data conforming to the color gamut, wherein
the conversion unit converts the plurality of image data into the display data conforming to a color gamut of the display device on the basis of the color gamut specified by the specifying unit.

9. A method for controlling an image processing apparatus configured to perform image processing on image data, the method comprising the steps of:
acquiring a plurality of image data;
converting the plurality of image data acquired in the step of acquiring into display data including a plurality of images each indicated by the plurality of image data, the plurality of images being to be displayed on one screen of a display device; and
specifying a color gamut, each of the plurality of image data conforming to the color gamut, wherein
the step of converting includes conversion of the plurality of image data into the display data conforming to a color gamut of the display device on the basis of the color gamut specified in the step of specifying.
